(19) United States
(12) Patent Application Publication
(10) Pub. No.: US 2023/0031295 A1
(43) Pub. Date: Feb. 2, 2023

(54) REDUCED POWER CLOCK GENERATOR FOR LOW POWER DEVICES

(71) Applicant: Advanced Micro Devices, Inc., Santa Clara, CA (US)

(72) Inventors: Thomas J. Gibney, Boxborough, MA (US); Alexander J. Branover, Boxborough, MA (US); Mihir Shaileshbhai Doctor, Santa Clara, CA (US); Xiaojie He, Austin, TX (US); Indrani Paul, Austin, TX (US); Benjamin Tsien, Santa Clara, CA (US); John P. Petry, Santa Clara, CA (US); Pitchaiah Katari, Madhapur (IN)

(73) Assignee: Advanced Micro Devices, Inc., Santa Clara, CA (US)

(21) Appl. No.: 17/390,475

(22) Filed: Jul. 30, 2021

(51) Int. Cl. G06F 1/324; G06F 1/3237; G06F 1/3218; G06F 1/08

(52) U.S. Cl. CPC G06F 1/324; G06F 1/3237; G06F 1/3218; G06F 1/08

(57) ABSTRACT

A disclosed technique includes triggering entry into a clock bypass mode, in which a bypass clock generator provides clock signals to functional elements and a primary clock generator does not provide clock signals to functional elements; and triggering exit from the clock bypass mode, in which the bypass clock generator does not provide clock signals to the functional elements and the primary clock generator does provide clock signals to the functional elements.

### BACKGROUND

Computing hardware consumes a large amount of power. Mobile devices that rely on batteries to supply this power benefit from power reduction in terms of increased operating duration. Power consumption concerns are thus a perpetual area for improvement for computing hardware.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 illustrates a device that is an example implementation of the device of FIG. 1;

FIG. 3 is a flow diagram of a method for operating a device according to a bypass clock mode, according to an example; and

FIG. 4 is a flow diagram of a method for operating a device according to another example.

### DETAILED DESCRIPTION

A disclosed technique includes triggering entry into a clock bypass mode, in which a bypass clock generator provides clock signals to functional elements and a primary clock generator does not provide clock signals to functional elements; and triggering exit from the clock bypass mode, in which the bypass clock generator does not provide clock signals to the functional elements and the primary clock generator does provide clock signals to the functional elements.

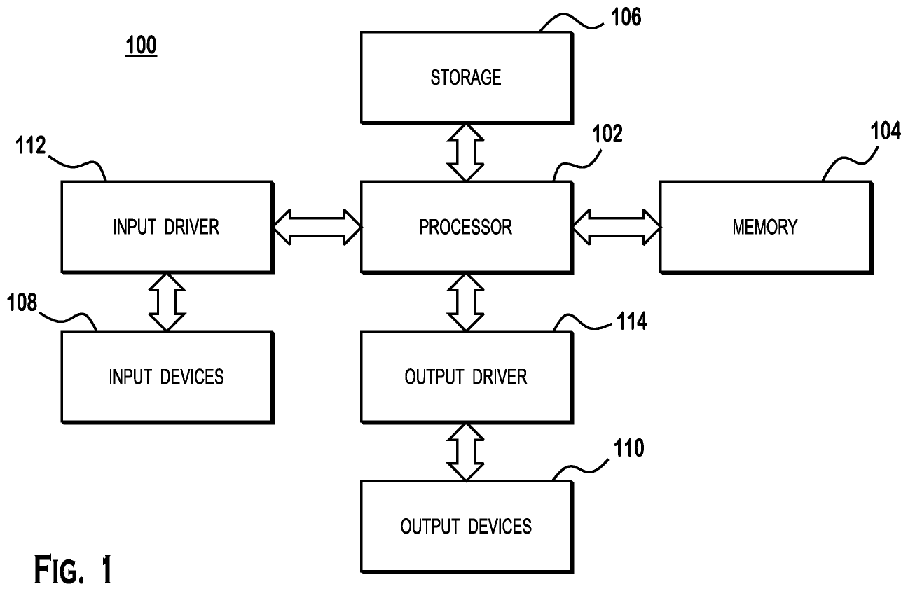

FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

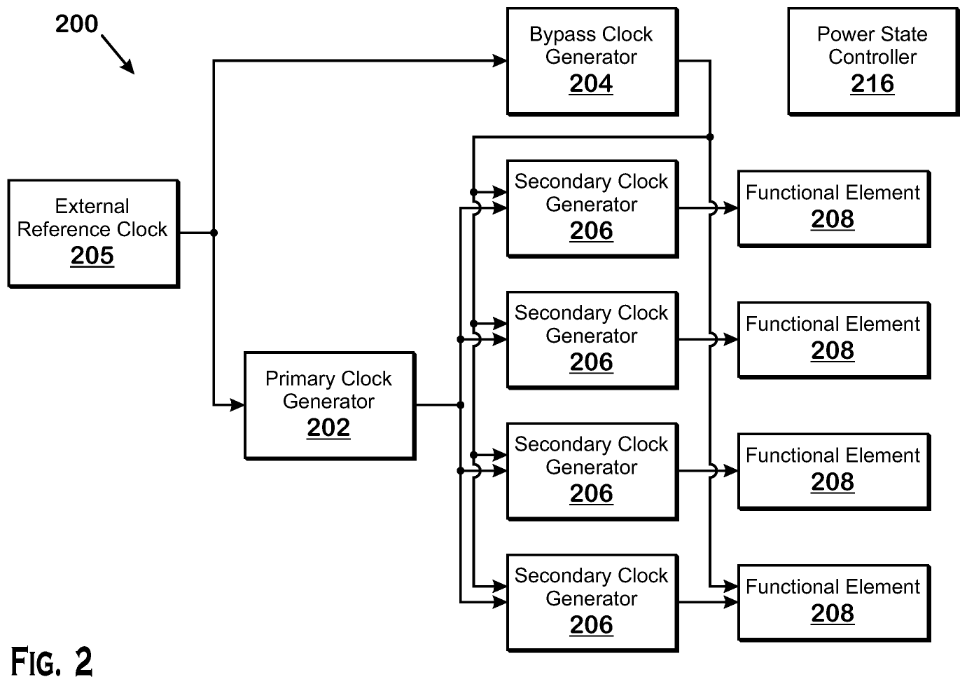

FIG. 2 illustrates a device 200 that is an example implementation of the device 100 of FIG. 1. The device 200 includes, without limitation, a primary clock generator 202, a bypass clock generator 204, a set of secondary clock generators 206, and a set of functional elements 208, as well as a power state controller 216.

The functional elements 208 are elements that perform the primary functionality of the device. In some examples, the functional elements 208 represent various elements of FIG. 1, such as the input drivers 112, processor 102, output drivers 114, or other elements. One example of a functional element 208 includes a display controller, which transmits pixel data to a display for display. Another example of a functional element 208 is a data fabric, which is a network for data transmission between elements (such as functional elements 208) of the device 200. Another example of a functional element 208 includes a memory controller, which accepts requests to access (read or write) memory and controls memory to service such requests. Another example of a functional element 208 includes a peripheral bus such as a universal serial bus (USB), along with the infrastructure for such bus within the device 200. It should be noted that this is not an exhaustive list of functional elements 208 and that many other types of functional elements 208 are possible.

The primary clock generator 202 generates one or more clock signals to be provided to a series of secondary clock generators 206. It should be understood that the clock signals are periodic, high frequency signals that control fundamental elements of circuitry, such as storage elements (e.g., flip flops). Typically, clock signals operate at a particular frequency and are approximately square waves. Clock signals can deviate from ideal square waves to different degrees depending on the clock generator. The secondary clock generators 206 convert the clock signal from the primary clock generators 202 into clock signals for use by the functional elements 208. The different functional elements 208 have different clock signal requirements. For instance, some functional elements 208 require different clock frequencies than other functional elements 208. In other examples, some functional elements 208 have certain requirements for clock signal quality, such as jitter, that are not requirements for other functional elements 208. The secondary clock generators 206 modify the clock signals output by the primary clock generator 202 to generate clock signals as needed by the functional elements 208. In an example, the secondary clock generators 206 are able to modify the frequency of an input clock signal, for example, by increasing the frequency by a multiplication factor or by reducing the frequency.

The power state controller 216 is capable of controlling the power state of one or more functional elements 208 or other portions (sometimes referred to herein as “power domains”) of the device 200. Different portions of the device 200 are capable of being set to different power states individually. A power state includes a definition of the degree to which a portion of the device 200 is powered up or down. In some examples, a portion of the device 200 has differing capabilities depending on which power state the device 200 is in. In an example, any of the functional elements 208 are capable of being set into lower or higher power states. In general, the differing capabilities in differing power states trade capability for power consumption. Specifically, by modifying operations for one or more components of a portion of the device 200, the capabilities associated with that component are modified, but the power that would normally be used by that component is not expended. In general, the power state controller 216 controls these power states according to various inputs, such as inputs from hardware units within the device 200 or software modules executing on a processor such as an operating system.

When many of the functional elements 208 are powered down by the power state controller 216, if the primary clock generator 202 remains powered on, the power dissipated by the primary clock generator 202 as well as the distribution network conveying the clock signal to the secondary clock generators 206, through to the functional elements 208, is relatively high. In other words, the primary clock distribution network, including the primary clock generator 202, the secondary clock generators 206, and the distribution wires that carry the clock signals to the functional elements 208, consume a relatively large amount of power when powered on even if some of the functional elements 208 are powered down and are thus not in need of clock signals.

For the above reasons, the device 200 includes a bypass clock generator 204. The bypass clock generator 204 is operable while the device is in a powered down state in which some of the functional elements 208 are powered down and thus do not require a clock signal. The bypass clock generator 204 has several characteristics that result in lower power dissipation while some functional elements 208, but not all functional elements 208 are powered up, and while the bypass clock generator 204 is operational and the primary clock generator 202 is powered down. Some examples of such characteristics are now provided.

In one example characteristic that makes the bypass clock generator 204 consume less power than the primary clock generator 202, the bypass clock generator 204 generates a more limited set of clock frequencies than the primary clock generator 202. This limit causes a lower amount of power dissipation because the bypass clock generator 204 can operate with a smaller set of circuitry components.

In another example characteristic that makes the bypass clock generator 204 consume less power than the primary clock generator 202, the bypass clock generator 204 meets a more lenient set of characteristics for clock signal generation than the primary clock generator 202. In one example, the bypass clock generator 204 has worse jitter than the primary clock generator 202. In some examples, jitter describes the accuracy of the high-to-low or low-to-high transitions of the clock signal. The most accurate transitions would occur exactly periodically. For example, a 1 gigahertz clock with “perfect” jitter characteristics would have transitions that occur exactly every one half nanosecond. A worse jitter means that the transitions do not occur exactly at these ideal times. The worse the jitter, the greater the deviation of the transitions from these ideal times.

In another example characteristic that makes the bypass clock generator 204 consume less power than the primary clock generator 202, the bypass clock generator 204 is coupled to, and thus provides clock signals to, fewer elements of the device, than the primary clock generator 202. Because of the smaller number of physical connections, the bypass clock generator 204 draws less power than the primary clock generator 202.

In another example characteristic that makes the bypass clock generator 204 consume less power than the primary clock generator 202, the bypass clock generator 204 is physically closer to the portions of the device 202 that are expected to receive clock signals from the bypass clock generator 204 while the device is operating in a power state in which the bypass clock generator 204 is enabled. In an example, the bypass clock generator 204 is used in a power state referred to as a “display stutter mode.” In the display stutter mode, elements other than a display controller are powered down, and the display controller provides pixel data to a display for display operation. The power state controller 216 periodically wakes up memory and a data fabric (the connection from the display controller to memory) to refill a buffer of the display controller with more data to be displayed, and then powers down those elements. In some implementations of the device 200 that perform operations of the display stutter mode, the bypass clock generator 204 is physically significantly closer to the display controller than the primary clock generator 202. This physical closeness reduces the length of the wires from the bypass clock generator 204 to the display controller, which reduces the power consumed.

The bypass clock generator 204 is capable of generating one or more clock signals suitable for certain of the functional elements 208. For scenarios in which a clock signal is required by one of the functional elements 208 that is not produced by the bypass clock generator 204, the bypass clock generator 204 is capable of outputting generated clock signals to one or more secondary clock generators 206. The one or more secondary clock generators 206 modify the clock signal, for example, by increasing or reducing the frequency of the signal.

In one example, a display controller operates in an ultra high definition mode that requires a clock frequency that is higher than any clock frequency that can be generated by the bypass clock generator 204. In this mode, the bypass clock generator 204 provides a clock signal to a secondary clock generator 206, and the secondary clock generator 206 increases the frequency of this clock signal and provides the increased clock signal to the display controller.

In operation, the power state controller 216 controls the device 200 to operate according to several power modes. In at least one such power mode, the primary clock generator 202 is powered on and the bypass clock generator 204 is powered off. In such one or more power modes, the primary clock generator 202 provides clock signals to the functional elements 208. Subsequently, the power state controller 216 determines that the device 200 is to enter into a lower power mode. The power state controller 216 makes such a determination based on operating aspects of the device 200, such as whether software executing on the processor 102 is active, whether user input as been received recently, or the like. The power state controller 216 powers down one or more functional elements, causes the primary clock generator 202 to power down, and causes the bypass clock generator 204 to power up. One or more functional elements 208 remain powered up. The bypass clock generator 204 provides clock signals to the functional element(s) 208 that remain powered up.

At a subsequent time, the power state controller 216 determines that the device 200 is to be placed in a higher power level, in which one or more functional elements 208 that are powered down and thus not receiving clock signals are powered up and should receive clock signals. In response, the power state controller 216 places the device 200 into such higher power level. The power state controller 216 triggers the bypass clock generator 204 to power down, triggers the primary clock generator 202 to power up, and triggers the one or more functional elements 208 to be powered up.

One example sequence of operations is now described. In this example, the device 200 is capable of operating in a display stutter mode. An element of the device 200, such as an operating system executing on the processor 102, determines that the device 200 is to operate in the display stutter mode. In an example, the operating system makes this determination based on a determination that the processor 102 has a certain degree of idleness. During this idleness, the power state controller 216 is able to shut down the processor 102 and other elements such as the memory 104 and data fabric (one of the functional elements 208) are shut down as well, but powered up as needed. The display controller (one of the functional elements) has an internal buffer that stores some data for output to a display (e.g., one of the output devices 110). Additional data for the frame is stored in the memory 104 (as generated, for example, by the processor 102 and/or a graphics processor). Thus when the display controller requires additional data for the internal buffer, the power state controller 216 wakes up the data fabric and the memory 104, as well as a memory controller. The display controller fetches the data from the memory 104, and the power state controller 216 powers the memory 104 and data fabric down. While the device 200 is operating in this display stutter mode, with at least the processor 102 and, optionally, other elements powered down, the power state controller 216 controls the primary clock generator 202 to be powered down and controls the bypass clock generator 204 to be powered up. The bypass clock generator 204 is providing the clock signals to the display controller through this entire sequence. It should be understood that the display stutter mode refers to the period of time where the display controller is transmitting data to the display, whether or not the data fabric and memory 104 are powered up and transmitting data to the display controller. The display stutter mode is a low power mode in that other elements, such as the processor 102, are powered down. When the power state controller 216 powers the device 200 up from the display stutter mode (for example, by powering up the processor 102), the power state controller 216 powers down the bypass clock generator 204 and powers up the primary clock generator 202, causing the primary clock generator 202 to provide clock signals to the functional elements 208 (including the display controller) and causing the bypass clock generator 204 not to be providing such clock signals to the functional elements.

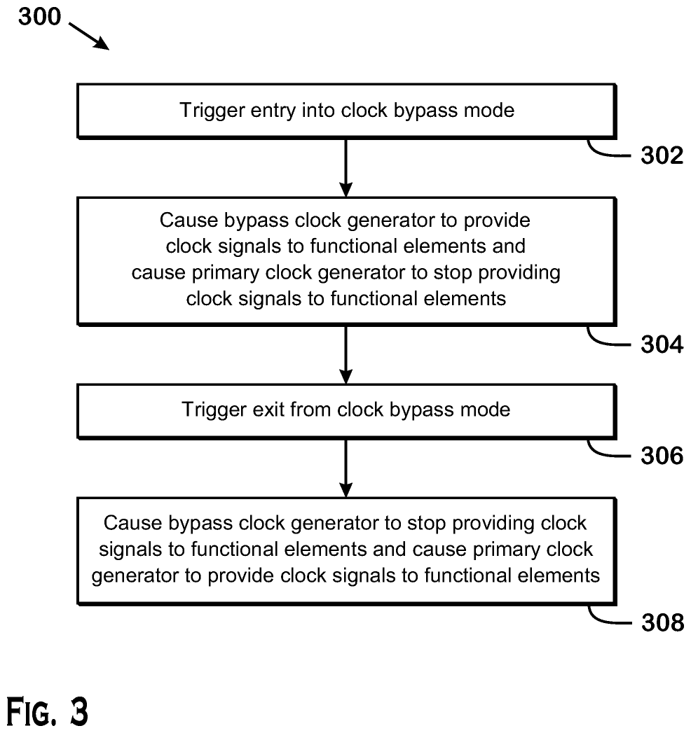

FIG. 3 is a flow diagram of a method 300 for providing clock signals for a device, according to an example. Although described with respect to the system of FIGS. 1 and 2, those of skill in the art will understand that any system configured to perform the steps of the method 300 in any technically feasible order falls within the scope of the present disclosure.

At step 302, a power state controller 216 triggers entry into a clock bypass mode. At step 304, in the clock bypass mode, a bypass clock generator 204, rather than a primary clock generator 202, provides clock signals to functional elements 208 of the device. At step 306, the power state controller 216 triggers exit from the clock bypass mode. At step 308, the power state controller causes the bypass clock generator 204 to stop providing signals to functional elements 208 and causes the primary clock generator 202 to provide clock signals to the functional elements 208.

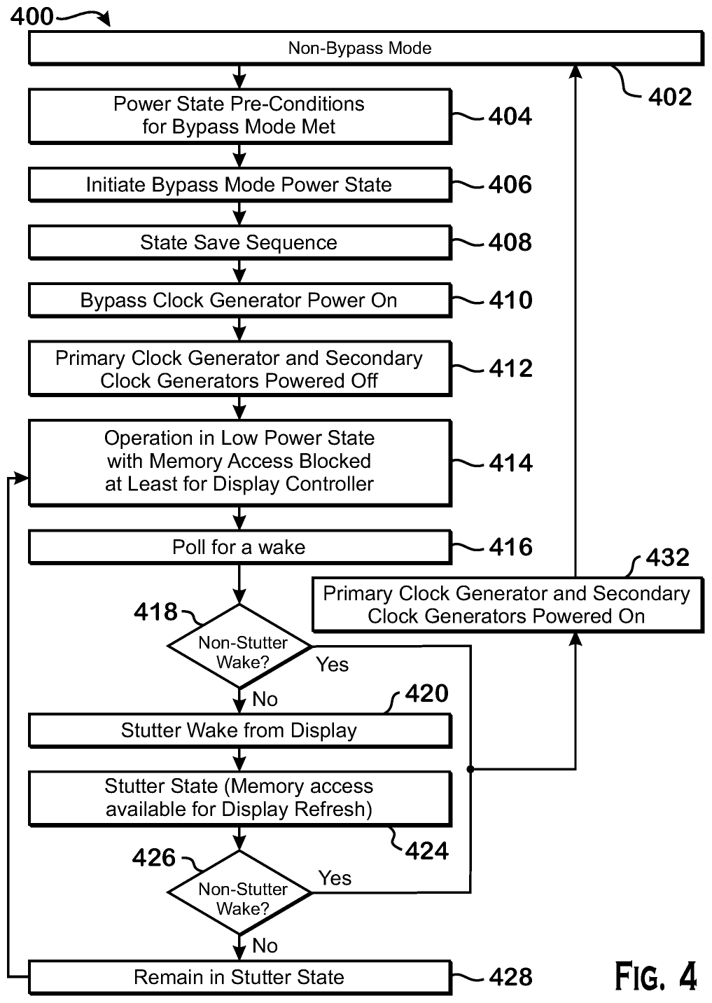

FIG. 4 is a flow diagram of a method 400 for operating a device, according to an example. Although described with respect to the system of FIGS. 1 and 2, those of skill in the art will understand that any system configured to perform the steps of the method 400 in any technically feasible order falls within the scope of the present disclosure.

At step 402, the device 200 is operating in a non-bypass mode. In this mode, the primary clock generator 202 is generating clock signals and providing those clock signals to the functional elements 208. At step 404, the power state controller 216 detects that the device 200 should enter into a bypass mode in which the primary clock generator 202 is not generating clock signals and the bypass clock generator 204 is generating clock signals for the device 200. In response to this detection, at step 406, the power state controller 216 initiates the bypass mode power state. At step 408, the device 200 performs a save state sequence, saving state of various functional elements 208 to a memory to allow those functional elements 208 to power down.

At step 410, the bypass clock generator 204 is powered up and at step 412, the primary clock generator 202 is powered down and the secondary clock generators 206 are powered down. At step 414, the device 200 operates in a low power state, with memory access blocked at least for a display controller. In some examples, the memory access is blocked because a memory and/or data fabric to the memory from the display controller is powered down.

At step 418, the power state controller 216 determines a wake that is not a “stutter wake.” A stutter wake is a wake of the data fabric and/or memory in order to refill the buffer of the display controller. A non-stutter wake is a wake (a request to power up one or more elements) other than a stutter wake. So, for example, a request to power up an element other than the memory or data fabric solely for the purpose of refilling the buffer of the display controller would be a non-stutter wake. If a non-stutter wake is detected, then the method 400 proceeds to step 432, and if a non-stutter wake is not detected, then the method 400 proceeds to step 420. At step 420, a stutter wake is performed, in which the memory and data fabric are woken up and powered by the bypass clock generator 204. At step 424, the display controller performs the stutter operations. At step 426, the power state controller 216 determines whether a non-stutter wake is to be performed. If not, the method 400 proceeds to step 428, and if so, then the method 400 proceeds to step 432. At step 432, the primary clock generator 202 powers on, the secondary clock generators 206 power on, and the method 400 returns to step 402. At step 428, the device 200 remains in the stutter state, and returns to step 414.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the primary clock generator 202, the bypass clock generator 204, the secondary clock generators 206, the functional elements 208, and the power state controller 216) may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A method, comprising:
triggering entry into a clock bypass mode, in which a bypass clock generator provides clock signals to functional elements and a primary clock generator does not provide clock signals to functional elements, wherein both the bypass clock generator and the primary clock generator provide clock signals to the functional elements through one or more secondary clock generators; and
triggering exit from the clock bypass mode, in which the bypass clock generator does not provide clock signals to the functional elements and the primary clock generator does provide clock signals to the functional elements.

2. The method of claim 1, wherein the bypass clock generator generates a smaller range of frequencies than the primary clock generator or generates a smaller number of frequencies than the primary clock generator.

3. The method of claim 1, wherein the bypass clock generator transmits clock signals to fewer functional elements than the primary clock generator.

4. The method of claim 1, wherein the bypass clock generator produces clock signals having worse jitter than the primary clock generator.

5. The method of claim 1, wherein the bypass clock generator is physically closer to the functional elements that receive the clock signals from the bypass clock generator than the primary clock generator.

6. The method of claim 1, wherein triggering entry into the clock bypass mode occurs in response to entry into a display stutter mode.

7. The method of claim 6, wherein operating in the display stutter mode comprises powering memory on and off in response to varying levels of data remaining in a buffer for a display controller.

8. The method of claim 6, wherein triggering exit from the clock bypass mode occurs in response to exit from the display stutter mode.

9. The method of claim 1, wherein the primary clock generator provides the clock signals to the functional elements through a set of one or more secondary clock generators.

10. A system, comprising:
a plurality of functional elements; and
a power state controller configured to:
trigger entry into a clock bypass mode, in which a bypass clock generator provides clock signals to functional elements of the plurality of functional elements and a primary clock generator does not provide clock signals to functional elements of the functional elements, wherein both the bypass clock generator and the primary clock generator are configured to provide clock signals to the functional elements through one or more secondary clock generators; and
triggering exit from the clock bypass mode, in which the bypass clock generator does not provide clock signals to the functional elements and the primary clock generator does provide clock signals to the functional elements.

11. The system of claim 10, wherein the bypass clock generator generates a smaller range of frequencies than the primary clock generator or generates a smaller number of frequencies than the primary clock generator.

12. The system of claim 10, wherein the bypass clock generator transmits clock signals to fewer functional elements than the primary clock generator.

13. The system of claim 10, wherein the bypass clock generator produces clock signals having worse jitter than the primary clock generator.

14. The system of claim 10, wherein the bypass clock generator is physically closer to the functional elements that receive the clock signals from the bypass clock generator than the primary clock generator.

15. The system of claim 10, wherein triggering entry into the clock bypass mode occurs in response to entry into a display stutter mode.

16. The system of claim 15, wherein operating in the display stutter mode comprises powering memory on and off in response to varying levels of data remaining in a buffer for a display controller.

17. The system of claim 15, wherein triggering exit from the clock bypass mode occurs in response to exit from the display stutter mode.

18. The system of claim 10, wherein the primary clock generator provides the clock signals to the functional elements through a set of one or more secondary clock generators.

19. A system, comprising:
a bypass clock generator;
a primary clock generator;
one or more secondary clock generators;
a plurality of functional elements; and
a power state controller configured to:
trigger entry into a clock bypass mode, in which the bypass clock generator provides clock signals to functional elements of the plurality of functional elements and the primary clock generator does not provide clock signals to functional elements of the functional elements, wherein both the bypass clock generator and the primary clock generator are configured to provide clock signals to the functional elements through the one or more secondary clock generators; and
triggering exit from the clock bypass mode, in which the bypass clock generator does not provide clock signals to the functional elements and the primary clock generator does provide clock signals to the functional elements.

20. The system of claim 19, wherein the bypass clock generator generates a smaller range of frequencies than the primary clock generator or generates a smaller number of frequencies than the primary clock generator.
